(19) United States
(12) Patent Application Publication
(10) Pub. No.: US 2018/0365656 A1
(43) Pub. Date: Dec. 20, 2018

(54) SYSTEM FOR EVENT RECOMMENDATION AND COORDINATION

(71) Applicant: CONNECTSPORTS LLC, ASTORIA, NY (US)

(72) Inventors: GAGE BRANDON MERSEREAU, ASTORIA, NY (US); CHRISTOPHER FRANCIS WASIK, KITCHENER (CA)

(21) Appl. No.: 16/008,738

(22) Filed: Jun. 14, 2018

Related U.S. Application Data
(60) Provisional application No. 62/520,338, filed on Jun. 15, 2017.

(51) Int. Cl. G06Q 10/10; G06F 17/30

(52) U.S. Cl. CPC G06Q 10/1095; G06F 17/30864

(57) ABSTRACT

A system for event recommendation and coordination includes an association server configured to receive athlete information pertaining to a plurality of athlete users, and recruiter information pertaining to a plurality of recruiter users. A database stores the athlete information, the recruiter information, and event information pertaining to a plurality of events. The browsing of the recruiter information, the event information, and the athlete information is permitted. Event recommendations recommending events for the respective user to attend are automatically generated and sent to the users. Calendars are maintained for each of the users. Each of the calendars is configured to include one or more of the events to which the corresponding user is either scheduled to attend or is scheduled to “maybe” attend.

### CROSS-REFERENCE TO RELATED APPLICATION

The present application is based on provisional application Ser. No. 62/520,338, filed Jun. 15, 2017, the entire contents of which are herein incorporated by reference.

### TECHNICAL FIELD

The present disclosure relates to event recommendation and, more specifically, to systems for recommendation and coordination of events.

### DISCUSSION OF THE RELATED ART

The process by which high school athletes join collegiate athletic programs is known as recruitment. During this process, representatives, such as college coaches, from collegiate athletic programs, referred to herein as recruiters, may observe high school athletes that may wish to participate in collegiate athletic programs, referred to herein as athletes, as they participate in sporting events. During these events, the recruiters may observe the athletic performance of the athletes and may use these observations to help determine which athletes to offer spots on their respective athletic programs to, and what sort of terms to extend, such as scholarship amounts, etc.

There may be a variety of sporting events in which recruiters may observe athletes. Both athletes and recruiters may decide for themselves which sporting events to participate in. However, it may be difficult for athletes and recruiters to determine which events to attend. The universe of potential athletes is large and recruiters have limited staff and travel budgets. Further, the National Collegiate Athletic Association (NCAA) imposes recruiting process rules that limit the number of days and location that recruit evaluations and thus recruiting events can take place.

### SUMMARY

A system for event recommendation and coordination includes an association server configured to receive athlete information pertaining to a plurality of athlete users, and recruiter information pertaining to a plurality of recruiter users, over at least one web portal. A database is accessible by the association server and is configured to store the athlete information and the recruiter information therein, and to further store event information pertaining to a plurality of events. The association server includes a browsing module configured to permit the athlete users to browse the recruiter information, to permit the athlete users to browse the event information, to permit the recruiter users to browse the athlete information, and to permit the recruiter users to browse the event information, over the at least one web portal. The association server further includes a matching module configured to automatically generate event recommendations to each of the recruiter users and the athlete users, the event recommendations recommending events for the respective user to attend. The association server further includes a scheduling module configured to maintain calendars for each of the athlete users and recruiter users, each of the calendars configured to include one or more of the plurality of events to which the corresponding user is either scheduled to attend or is scheduled to “maybe” attend.

A method for event recommendation and coordination includes receiving event information pertaining to a plurality of events. Athlete information pertaining to a plurality of athletes is received. Athlete attendance information pertaining to events of the plurality of events that the plurality of athletes are scheduled to attend is received. Athletic program information pertaining to a plurality of athletic programs is received. Recruiter information pertaining to a plurality of recruiters associated with the plurality of athletic programs is received. Recruiter attendance information pertaining to events of the plurality of events that the plurality of recruiter are scheduled to attend is received. Athlete event recommendations are generated recommending attendance of each of the plurality of athletes to one or more events of the plurality of events, based on the athlete information, the athlete attendance information, the athletic program information, the recruiter information, athlete interest in specific programs, and the recruiter attendance information. Recruiter event recommendations are generated recommending attendance of each of the plurality of recruiters to one or more events of the plurality of events, based on the athlete information, the athlete attendance information, the athletic program information, the recruiter information, and the recruiter attendance information.

A computer system includes a processor and a non-transitory, tangible, program storage medium, readable by the computer system, embodying a program of instructions executable by the processor to perform method steps for event recommendation and coordination. The method includes receiving event information pertaining to a plurality of events. Athlete information pertaining to a plurality of athletes is received. Athlete attendance information pertaining to events of the plurality of events that the plurality of athletes are scheduled to attend is received. Athletic program information pertaining to a plurality of athletic programs is received. Recruiter information pertaining to a plurality of recruiters associated with the plurality of athletic programs is received. Recruiter attendance information pertaining to events of the plurality of events that the plurality of recruiter are scheduled to attend is received. Athlete event recommendations are generated recommending attendance of each of the plurality of athletes to one or more events of the plurality of events, based on the athlete information, the athlete attendance information, the athletic program information, the recruiter information, recruiter interest in specific athletes, and the recruiter attendance information. Recruiter event recommendations are generated recommending attendance of each of the plurality of recruiters to one or more events of the plurality of events, based on the athlete information, the athlete attendance information, the athletic program information, the recruiter information, and the recruiter attendance information.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a system for event recommendation and coordination in accordance with exemplary embodiments of the present invention;

FIG. 2 is a representative illustration of a database element for athlete profile information in accordance with exemplary embodiments of the present invention;

FIG. 3 is a representative illustration of a database element for recruiter profile information in accordance with exemplary embodiments of the present invention;

FIG. 4 is a representative illustration of a database element for athletic program information in accordance with exemplary embodiments of the present invention;

FIG. 5 is a schematic diagram illustrating an algorithm of a browsing module of an association server in accordance with exemplary embodiments of the present invention;

FIG. 6 is a schematic diagram illustrating an algorithm of a matching module of an association server in accordance with exemplary embodiments of the present invention;

FIG. 7 is a schematic diagram illustrating an algorithm of a scheduling module of an association server in accordance with exemplary embodiments of the present invention;

FIG. 8 is a schematic diagram illustrating an algorithm of a notification module of an association server in accordance with exemplary embodiments of the present invention; and

FIG. 9 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for the sake of clarity. However, the present disclosure is not intended to be limited to the specific terminology so selected, and it is to be understood that each specific element includes all technical equivalents which operate in a similar manner.

Exemplary embodiments of the present invention relate to analytical systems for receiving, storing, and managing data used in athletic recruitment, and for providing various advantages such as minimizing data entry tasks, minimizing data storage requirements, speeding up the dissemination of pertinent information, etc. by automatically linking tasks associated with browsing athlete and athletic program information, matching athletes with athletic programs, managing athlete and recruiter scheduling, and notifying athletes and recruiters of athlete/recruiter scheduled and actual attendance of recruitment events. By automating and linking these tasks, significant advantages may be achieved over conventional stand-alone tools for information retrieval and schedule management.

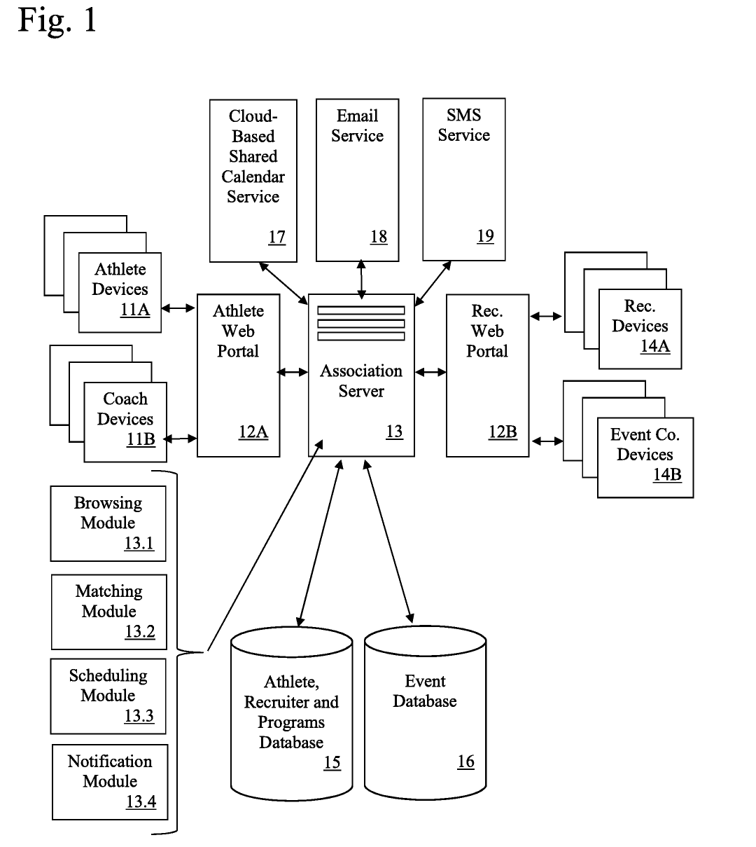

FIG. 1 is a schematic diagram illustrating a system for event recommendation and coordination in accordance with exemplary embodiments of the present invention. As can be seen in the figure, there is a plurality of athlete devices 11A, a plurality of club team coach devices 11B, a plurality of recruiter devices 14A, and a plurality of event coordinator devices 14B. Each of these devices may be embodied as a fixed or mobile computer device such as a mobile phone/smartphone, a tablet computer, a personal computer (PC)/laptop/notebook PC, etc. Each device may be in communication with a respective web portal. For example, the athlete devices 11A and club team coach devices 11B may be in communication with an athlete web portal 12A while the recruiter devices 14A and the event coordinator devices 14B may be in communication with a recruiter web portal 12B. This communication may be performed over a wide area network (WAN) such as the Internet. The communication may be handled by either a web browser running on each device 11A/11B/14A/14B which connects to the respective web portal via the world wide web, or the communication may be handled by an application running on each device.

The athlete and recruiter devices 11A and 14A may be used by athlete users and recruiter users, respectfully. The club coach and event coordinator devices 11B and 14B may be used by club coach users and event coordinator users, respectfully. However, it is noted that the present invention is not limited to use by athletes, recruiters, club coaches, and event coordinators and may be applied to any classes of users that are engaged in a matching program. It is merely required that there be at least two classes of users and the users from the first class are looking to be connected to a user of the second class, and vice versa.

Each athlete user may maintain an athlete account and may access the athlete account through an athlete device (although not necessarily from the same athlete device). Similarly, each recruiter user may maintain a recruiter account and may access the recruiter account through a recruiter device (although not necessarily from the same athlete device). Exemplary embodiments of the present invention may also utilize athletic program accounts and these accounts may be managed by a user of the athletic program, such as, but not necessarily limited to, the recruiter users. As will be described in more detail below, an athletic program account may have a set of recruiter accounts associate with it. The associated recruiter accounts may represent those recruiters that recruit on behalf of the associated athletic program.

Similarly, exemplary embodiments of the present invention may utilize club coach accounts. A club coach account is an account that may be used by a user responsible for managing a team or club of athletes, such as a travel, club or high school coach. It is to be understood that in matching athletes to recruiters, the club coach account represents athletes looking to be recruited while the athletic program account represents athletic programs that use recruiters to find athletes. For example, an athlete may be a high school athlete presently playing with a club team. The athletic program may be a collegiate sports team, and the recruiters may represent the collegiate sports teams in finding athletes to join the collegiate sports teams.

Each web portal 12A/12B provides, to its respective devices 11/14, various forms for collecting data to be stored as a database element with an athlete, recruiter, and programs database 15 (ARP DB). The web portals 12A/12B are in communication with an association server 13, which mages authentication and data collection tasks and stores/retrieves data from the ARP DB 15. The association server 13 may be a single or distributed computer system that includes modules for performing various tasks. For example, the association server 13 may include a browsing module 13.1 for facilitating the athlete devices 11 in browsing information of athletic programs stored in the ARP DB 15 and for facilitating the recruiter devices 14 in browsing athlete information stored in the ARP DB 15.

The association server 13 may further include a matching module 13.2 configured for presenting athletic program match candidates to the athlete devices 11 and for presenting athlete match candidates to the recruiter devices 14.

The association server 13 may further include a scheduling module 13.3 configured for managing the availability of each athlete account and each recruiter account, for example, by interfacing with a cloud-based shared calendar service such as GOOGLE CALENDAR, a time-management and scheduling calendar service developed by Google LLC, a subsidiary of Alphabet Inc. Each athlete user account and each recruiter user account may be associated with a corresponding account on the calendar service, or the association server 13 may manage calendar scheduling through the scheduling module 13.3 itself.

The scheduling module 13.3 may obtain information pertaining to a plurality of recruitment events. Recruitment events may be athletic displays, such as matches and tournaments, where recruiter users may observe athlete users. The information pertaining to the recruitment events may be provided by either athlete users, recruiter users, or from some other class of users such as event coordinator users. Alternatively, recruitment event information may be obtained by web crawlers or other automated bots designed to glean information from public online sources.

According to some exemplary embodiments of the present invention, event coordinator users may plan an event in which multiple athlete users perform in the presence of one or more recruiters. Recruiters may attend an event because of the athletes present and/or in exchange for valuable consideration, exemplary embodiments of the present invention may grant an event coordinator account authorization to add one or more recruiters, en masse, to an event using the scheduling module 13.3.

Moreover, event coordinators need not be the only class of user account that may create and modify events and add recruiters, en masse, to event schedules. For example, recruiter accounts may also have this capability.

Similarly, a club coach user account may be granted authority within the scheduling module 13.3 to add every athlete associated to the club coach user account, en masse, to an event. The club coach user account may also have the capability to create an event.

The association server 13 may store recruitment event information within an event database 16 and the scheduling module 13.4 may use this information to generate calendar entries of the calendar accounts associated with the user accounts, based on stated preferences, matched preferences, and real-time attendance information, as is described in more detail below.

The association server 13 may further include a notification module 13.4 configured for disseminating data across the classes of users. For example, the notification module 13.4 may obtain scheduling information from the scheduling module 13.3 and use this information to notify users of scheduled events, scheduling conflicts, scheduling changes, and the like. The notification module 13.4 may obtain potential matches from the matching module 13.2 and use this information to notify users of new potential matches. The notification module 13.4 may also notify interested users as to changes of the data stored within the ARP DB 15.

The notification module 13.4 may push notifications to the various users by generating internal notifications that are visible to the various user accounts through the web portals 12A/12B. The notification module 13.4 may push notifications via email to email accounts associated with the user accounts using an email service 18. The notification module 13.4 may push notifications via text messages (e.g. SMS, MMS, etc.) to mobile phone numbers associated with the user accounts using an SMS service 19.

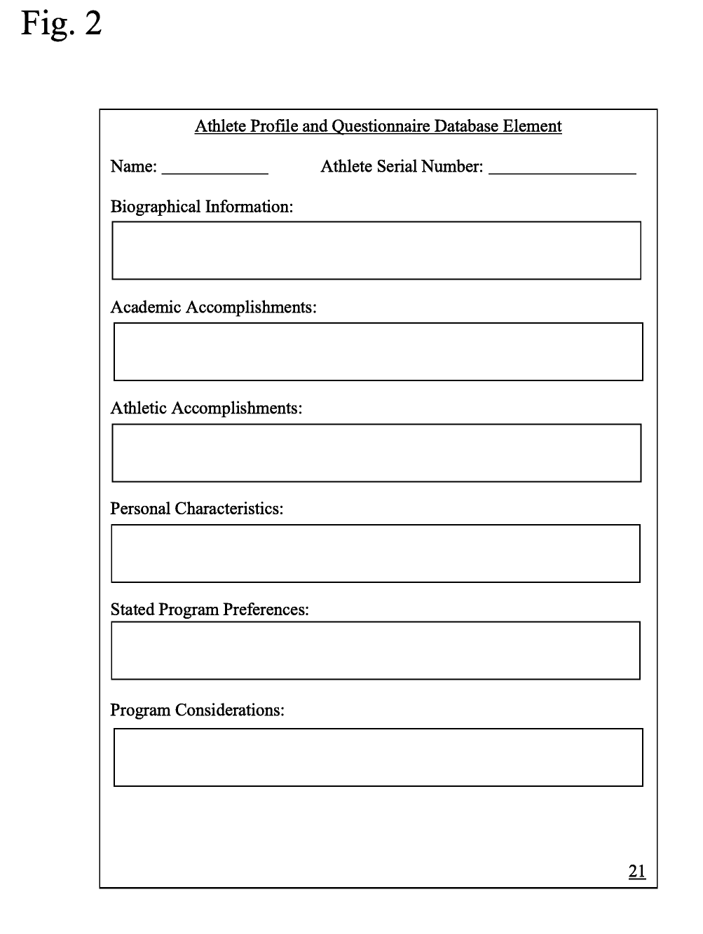

As discussed above, the web portals 12A and 12B may facilitate the collection of user data by the association server 13 for storage in the ARP DB 15. This may be performed, for example, by sending to the various devices 11/14, questionnaires, and returning to the association server 13, user data for storage in the ARP DB 15. FIGS. 2-4 show examples of database entries of the ARP DB 15 that are generated by the association server 13 using information provided by the devices 11/14 over the web portals 12A/12B. However, it is to be understood that these database entries are not intended to show all information so-provided, and are instead, merely an example of some information that may be collected, stored, and managed in accordance with exemplary embodiments of the present invention.

FIG. 2 is a representative illustration of a database element for athlete profile information in accordance with exemplary embodiments of the present invention. This database element may include the name of the athlete, a unique serial number ID associated with the athlete, biographical information, academic qualifications, athletic qualifications, personal characteristics, stated preferences for athletic programs, various considerations/priorities for finding an athletic program, etc. This information may be provided by athlete users using athlete devices that are logged into athlete accounts on the association server 13 via the athlete web portal 12A. The database element for athlete profile information may further include an association with one or more club coach user accounts so that the associated club coach user accounts may be authorized to manage event participation for that athlete user account.

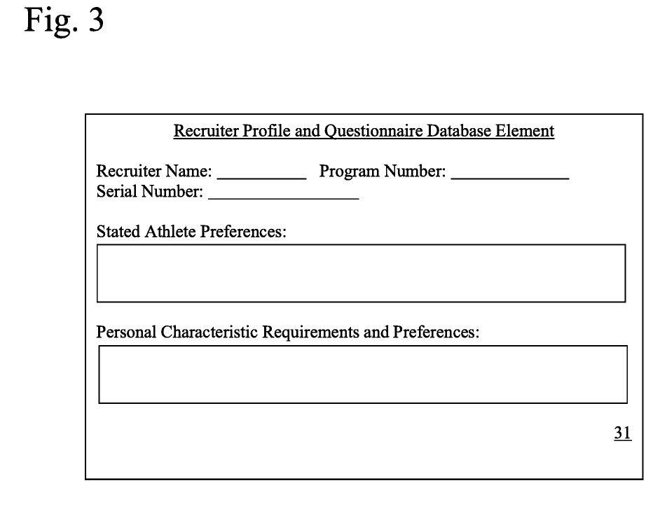

FIG. 3 is a representative illustration of a database element for recruiter profile information in accordance with exemplary embodiments of the present invention. This database element may include the name of the recruiter, a unique serial number ID for the recruiter, the name of one or more athletic programs the recruiter is associated with (as the recruiter may represent multiple such athletic programs), stated preferences for athletes, academic requirements for athletes, athletic requirements for athletes, personal characteristics and requirements preferences for athletes, etc. This information may be provided by recruiter users using recruiter devices that are logged into recruiter accounts on the association server 13 via the recruiter web portal 12B.

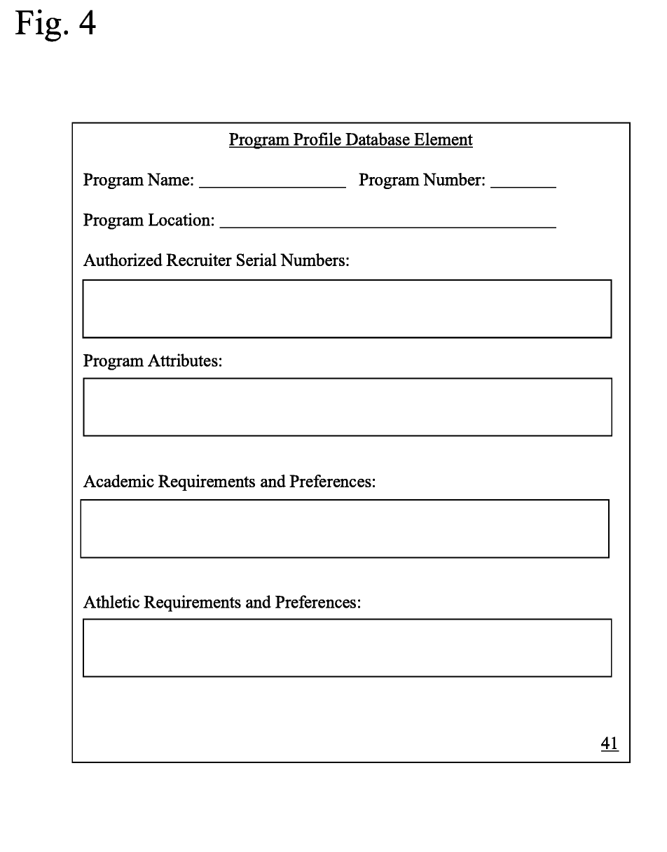

FIG. 4 is a representative illustration of a database element for athletic program information in accordance with exemplary embodiments of the present invention. This information may be provided by a recruiter associated with the athletic program or by some other source/class of user. This database element may include the name of the athletic program and/or a unique program number, a location (e.g. campus) of the athletic program, a list of authorized recruiters, for example, by unique serial number, and program attributes including all of the information needed for an athlete to select one athletic program over another. This information may be provided by authorized recruiter users, or other representative users, using recruiter devices that are logged into recruiter accounts on the association server 13 via the recruiter web portal 12B.

It is to be understood that the above-described database elements are not intended to be complete and that other information may be provided to the association server 13 and stored in the ARP DB 15 in a similar manner. For example, the athlete web portal 12A may display, to the athlete devices 11, a user interface though which the athletes provide personal information, academic information, personal characteristics, athletic accomplishments, preferences, list of most desired athletic programs, and the like. The personal information may include biographical information such as date of birth, place of residence, high school of attendance/athletic club/athletic travel team, and the like. The academic information may include classes taken, grades received, standardized test scores, and other information pertinent to college admissions. The personal characteristics may include details that are pertinent to athletic performance such as height, weight, dominant hand, and the like. The athletic accomplishments may include history of athletic play, positions played, combine testing, competitions and awards won, etc. The preferences may include geographic location where the recruit wishes to attend college, type of college the recruit wishes to attend, majors of interest, athletic division number and relative strength of the athletic program, and other such information pertaining to the desired characters of the athletic program and college. The athletes may also select a top set of athletic programs/colleges that they are interested in.

For example, the recruiter web portal 12B may be configured to receive, from the recruiter devices 14, data pertaining to the type of athletes the recruiters are looking for, as well as a set of most desired athletes. The type of athletes the recruiters are looking for may include ranges of characteristics that the recruiter is looking for, and a level of importance the recruiter attributes to each characteristic. These characteristics may be similar to the characteristics the athletes provide, as discussed above. The set of most desired athletes may be provided in the form of names.

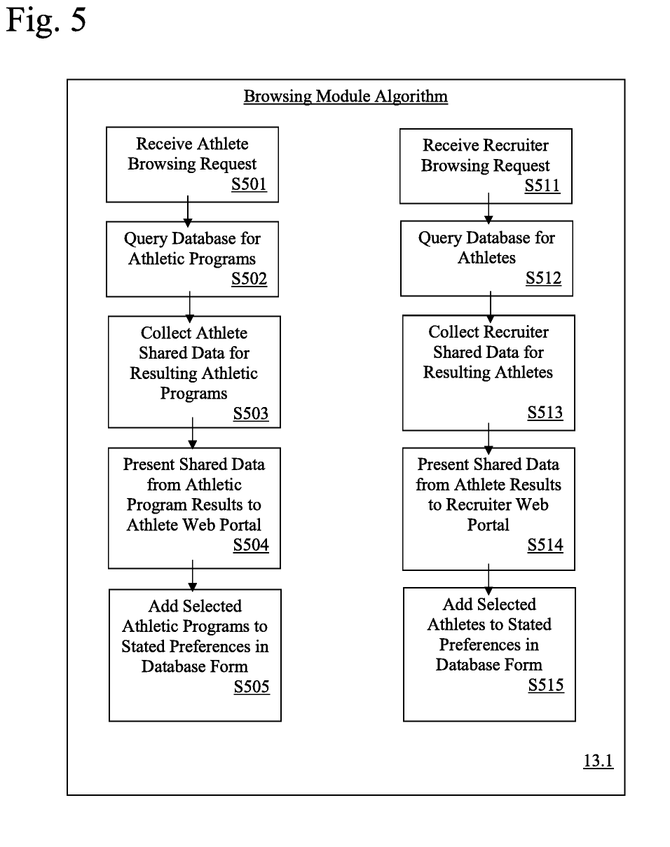

As discussed above, the association server 13 may utilize a plurality of modules for performing various functions. Each of these modules may be instantiated as a microprocessor executing a sequence of algorithmic instructions. FIGS. 5-8 are schematic diagrams illustrating exemplary algorithms that may be executed by the various modules. FIG. 5 is a schematic diagram illustrating an algorithm of a browsing module 13.1 of an association server 13 in accordance with exemplary embodiments of the present invention. The browsing module may receive an athlete browsing request (Step S501). The athlete browsing request may be made by an athlete user logged into an athlete account though an athlete device 11. The browsing request may be a request to begin an athletic program browsing operation which may be set up for browsing athletic programs and events to which the recruiters of the athletic program are scheduled to attend. The association server 13, may thereafter query the ARP DB 15 for information pertaining to the various athletic programs (Step S502). Some of this information may be restricted information that is unavailable to the athletes, however, some information is shared data that is in place to aid the athlete users in selecting athletic programs. This shared data may be referred to herein as athlete-shared data, as it is data that is intended to be shared with the athlete accounts. The athlete-shared data may be collected for each athletic program (Step S503). The athlete-shared data may thereafter be presented to the athlete account, via the web portal, in the form of a list of athletic programs and one or more attributes (Step S504). The web portal may sort this information in a selected manner and may display or hide information, as selected by the athlete account. The web portal may provide a user interface with which the athlete user may add or remove athletic programs from the stated preference list of that athlete user (step S505).

The browsing module 13.1 may also be used to collect information pertaining to users' browsing choices and this information may be used to build and improve upon the matching module 13.2. For example, as will be described in detail below, the matching module 13.2 may employ computer learning to perform automatic match suggestions, and while the computer learning models may be trained using training data, these models may be improved upon, during use, by the data collected by the browsing module 13.1 pertaining to users' browsing preferences.

Similarly, the browsing module is configured to receive a recruiter browsing request to browse from among the athlete users (Step S511). The database queries for information pertaining to the athletes (Step S512) and data associated with the athletes that is designated to be shared with recruiters (recruiter-shared data) is collected (Step S513), and in a manner that parallels the process described above, the data is presented to the recruiter accounts as a sortable list (Step S514). The user interface generated by the recruiter web portal allows for the recruiter to add or remove athletes from stated preferences (Step S515).

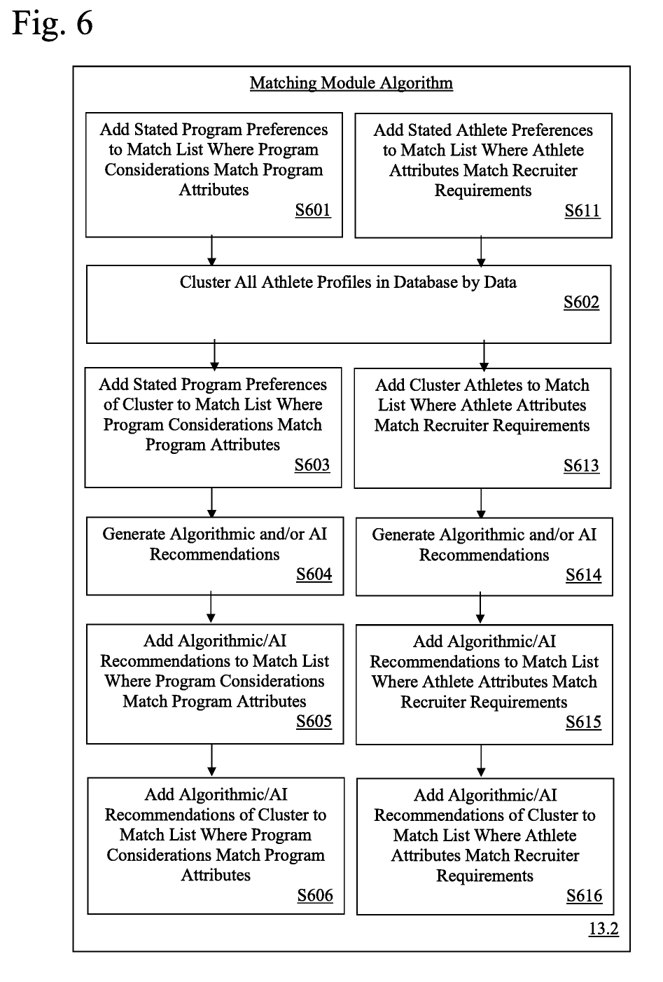

FIG. 6 is a schematic diagram illustrating an algorithm of a matching module 13.2 of an association server 13 in accordance with exemplary embodiments of the present invention. The matching module 13.2 is configured to add to the match lists of athletes and recruiters based on automatically generated matches. The match lists are lists that include the stated preferences discussed above and further include matched preferences. The match lists may be used by the scheduling modules and the notification module, and serve as links between athletes and recruiters. The matching module may begin by adding stated preferences of the athlete to the athlete's match list (Step S601) and by adding stated preferences of the recruiter to the recruiter's match list (Step S611). In both cases, stated requirements and preferences may be matched against attributes so as to identify where a stated preference may be unjustified or inadvisable and these entries may be removed from the match lists or the user may otherwise be made aware of the mismatch.

Athlete user accounts may then be clustered according to their associated data (Step S602). The clustering may utilize all athlete data and need not be limited to recruiter-shared athlete data. Clustering may be used to generate groups (i.e. clusters) of athletes with similar qualifications and/or interests. Then, the match lists of the various athletes may be updated by adding thereto the stated preferences of other athletes in the cluster, to the extent that stated requirements are satisfied by stated attributes (Step S603). In this way, the match lists of each athlete may grow to incorporate stated preferences of matched athletes.

Similarly, the match lists of recruiters may be expanded to include not only the stated athlete preferences but also other members of the clusters for those athletes whose attributes satisfy requirements (Step S613).

Algorithmic and/or artificial intelligence matching may be performed to generate additional recommendations (Step S604 and Step S614). Algorithmic matching includes any algorithms employed to generate matches between the properties and preferences of each party, whereas AI matching includes approaches for using computer learning to generate such matches. The hits from the algorithmic and/or artificial intelligence matching may then be added to the corresponding match lists to the extent that attributes satisfy requirements (Steps S605 and S615). Thereafter, the clusters of the algorithmic/AI matches may be used to find yet more matches, and the matches whose attributes satisfy requirements may be added (Step S606 and Step S616).

The respective users may be given an opportunity to accept or reject additions to the match lists and the notification module 13.4 may be responsible for notifying the users of their automatic matches, for example, in the manner described above.

As described above, the matching module may perform clustering and algorithmic/AI matching. It is noted, however, that these matching techniques may be performed using a weighting of attributes in which stated preferences are assigned a weighting by the users.

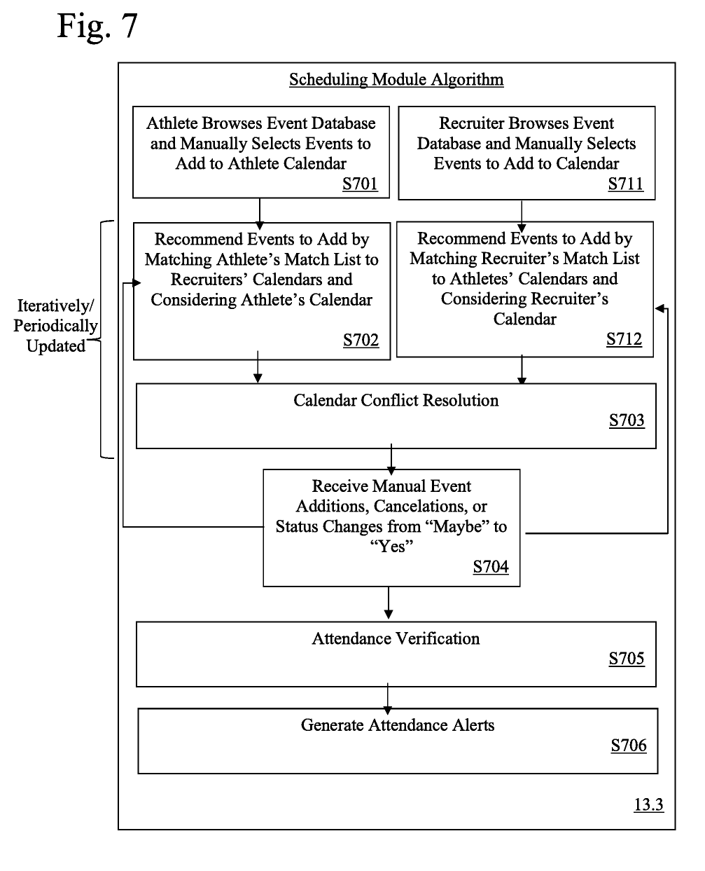

FIG. 7 is a schematic diagram illustrating an algorithm of a scheduling module 13.3 of an association server 13 in accordance with exemplary embodiments of the present invention. The scheduling module may be responsible for creating calendar events for athletes and recruiters for the recruitment events that each user may choose to attend. As mentioned above, the association server 13 may maintain an event database 16 that includes a list of all recruitment events known to the system. The scheduling model, e.g. in association with the browsing module, may establish a user interface by which each user may browse the events of the database and manually select events (Step S701 and Step S711). Selecting an event may either be binary (e.g. “will attend” or “will not attend”) or other options may be available, such as “interested” or “maybe”. A recommended event, from the point of view of an athlete, is any event that a recruiter associated with a program on the match list of the athlete is scheduled to or may attend and, from the point of view of a recruiter, is any event that an athlete on the match list of the recruiter is scheduled to or may attend. However, events may also be recommended according to matching algorithms/AI approaches.

Recommendation may be performed by applying a weighting to various factors such as, from the perspective of the athlete user, how many recruiters associated with match list programs are scheduled to attend and how many recruiters associated with match list programs are set to “maybe” attend. The weighting may determine the relative significance of a recruiter being scheduled to attend and a recruiter indicating “maybe” attending. This weighting may be based on a historical counting of how many times recruiters in general, or perhaps that particular recruiter (where the data is available) winds up attending an event designated as “maybe” as compared to the likelihood that recruiter would attend the event if the designation is “will attend.” If recruiters are twice as likely to actually attend an event marked “will attend” than “maybe” then the indication of “will attend” will be given twice the weight in generating recommendations.

Recommended events may be added to the schedules of the respective users as a “maybe” status, to the extent that there is no scheduling conflict, which is to say, there is not already an event on that day and the new event would not create a logistical challenge with respect to other events on the schedule (e.g. events cannot be too closely placed together and appropriate travel time is considered) (Step S702 and Step S712).

To the extent that a recommended event conflicts with an existing event or another recommended event, resolution may thereafter be perfobrmed (Step S703). Resolution may include running an optimization algorithm to maximize event impact within the available schedule, where each event is given a score relative to its extent of importance and then a set of non-conflicting events is created to maximize cumulative score. The users may thereafter be made aware of automatic selections and optimizations so that the users may override automatic additions and/or change importance scoring.

The steps of adding recommended events (Steps S702 and S712) and performing conflict resolution (Step S703) may be iteratively and/or periodically performed as data changes and new events are created and subsequent changes and additions may be used to create new user notifications and opportunities to accept or reject changes. Additionally, when a user changes an attendance from between “will attend” or “will not attend” and “interested” or “maybe,” the events in question may be reconsidered (Step S704). For example, when an athlete user or club coach user changes status, reconsideration may be performed for recruit users and event coordinator users and when a recruit user or an event coordinator user changes status, reconsideration may be performed for athlete users and club coach users.

The scheduling module algorithm may optionally include an attendance verification step that verifies the actual attendance of users who had indicated “will attend” or “interested” (Step S705) and in response, real-time attendance alerts may be sent to interested users (users who had selected a particular event at least in part due to the expected attendance of the user whose presence has been verified (Step S706). Attendance verification may be provided by querying a GPS module of the athlete/recruiter devices 11/14. Going forward, actual attendance results may be used to estimate a likelihood of a user attending after having indicated “will attend” or “interested” and this likelihood may be used as a factor in automatic match recommendations.

The scheduling module may use the information it receives to update the corresponding cloud-based calendars, and where third party calendar services are used, this capability may be implemented by a calendar being shared between each user and the association server and the association server can be granted permission to add or remove an event from each shared calendar. In this way, the association server may maintain a shared calendar corresponding to each user.

As described above, the scheduling module may permit one class of user to change not only its own schedule, but may additionally permit one class of user to change the schedule of another class of user that has been associated thereto. For example, a club coach user may add an event to the schedule of each athlete account associated therewith and an event coordinator may add an event to the schedule of each recruiter account associated therewith. According to an exemplary embodiment of the present invention, when a user is added to an event in this manner, the user may be added with a “maybe” or “interested” status and the scheduling module may send an alert to that user so-added to provide that user with an opportunity to accept or reject the addition and thereby change the status accordingly.

Moreover, the scheduling module may make public to all users the status of who is attending, who is not attending and who has an “interested” or “maybe” status associated with each event. According to exemplary embodiments of the present invention, the scheduling module may periodically or continuously search all calendar accounts and add to a description of each event, a list of which athletes are scheduled to attend, which recruiters are scheduled to attend, and which of these users has an “interested” or “maybe” status associated with the event. These results may then be added to a description of the event so that users browsing events, for example, using the browsing module 13.1, may see scheduled attendance. These results may also be added to a description of each athlete and each recruiter and/or athletic program so that a user browsing events, for example, using the browsing module 13.1, may see scheduled attendance.

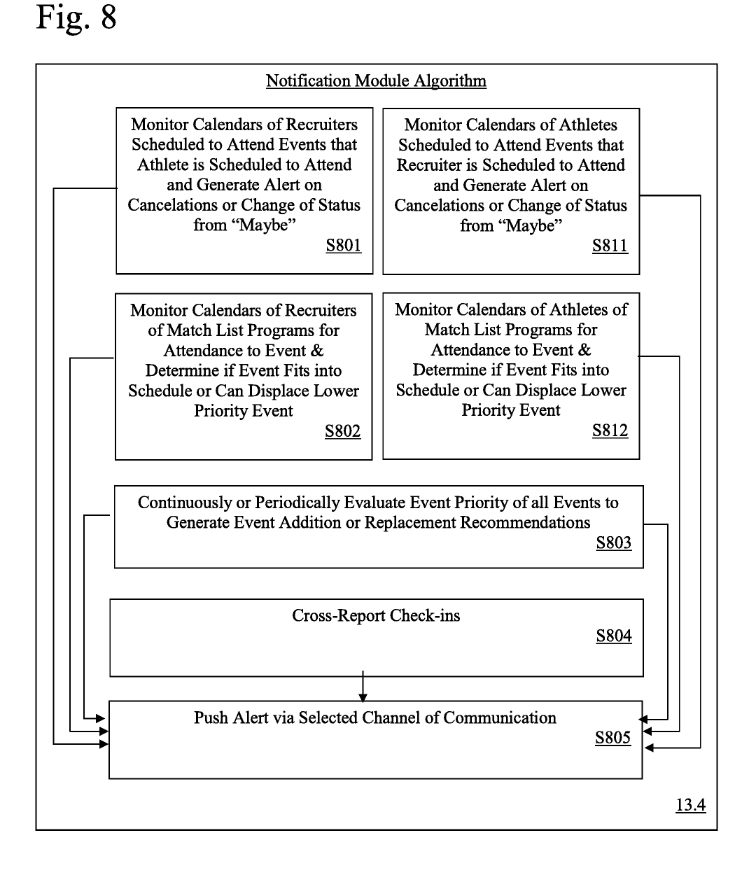

FIG. 8 is a schematic diagram illustrating an algorithm of a notification module 13.3 of an association server 13 in accordance with exemplary embodiments of the present invention. The notification module, acting in association with the scheduling module, may monitor the calendars of recruiters and athletes to determine which events are pertinent to each user and then to generate notifications to alert the corresponding user of changes to the event or its attendance that would be pertinent to the user (Steps S801 and S811). Additionally, the calendars of watch list members may be monitored on behalf of each user to determine if there is a change to an opportunity to participate in an event that will be attended by the users on the watch lists (Steps S802 and S812). Additionally, event priority may be periodically or continuously re-evaluated, and conflict resolution performed again to see if recommendations may change (Step S803).

As discussed above, actual attendance confirmations, which may be referred to herein as “check-ins” may generate notifications (Step S805). Regardless of how the alerts are generated, each generated alert may be pushed through to a desired channel of communication, which may include email, text messages, application alerts, etc. (Step S805).

While various functional modules of the association server may be provided, it is to be understood that other functional modules may be included. For example, the association server may maintain a database of multimedia content associated with each user. This content may include gains in which an athlete has participated and such multimedia contend may be associated with each athlete that has participated in the game so that a single game file need not be stored separately for each athlete that participated in the game. The browsing module may then make these multimedia files available to recruiter users, for example as a link or embedded content. The multimedia files may be keyed with the times in which each athlete is observable so that highly relevant portions of the files may be surfaced.

Recruiting events may also be wholly recorded and the option to view recorded events, after the fact or in real-time, may be recommended to recruiter users who were recommended to attend an event but could not or did not happen to attend the event. Once again, the recording may be keyed to certain moments in time in which the desired athlete is active.

Event recommendation may further take into consideration availability data and event type. For example, an event run by a recruiter and/or run at a college may be given enhanced recommendation to athletes. The association server may access the calendar accounts of each recruit/recruiter to see availability information and to draw inferences about the practicality of attending additional events, based on timing and geographic location. The association server may recommend participation/attendance of additional events based on the above matching to the extent that travel is practical, and may also recommend canceling one event to participate/attend in one or more other events, where doing so would be calculated to optimize the itinerary of each recruit/recruiter.

Itinerary optimization may be performed by the association server and may include assigning every event candidate a fitness score, as determined by the matching described above. Each athlete users/recruiter users (collectively referred to as users) may provide attendance constraints such as how many events may be attended, how far each user is willing to travel, how close together in time and distance consecutive events may be, etc. and the association server may determine which selection of event candidates maximizes the sum of all fitness scores. Itinerary optimization may be used either to automatically generate the agenda of each user, or to simply recommend modifications be made to an existing agenda. The output of the itinerary optimization may be provided in the form of event requests sent to the calendar service that the user may accept or decline. Itinerary optimization may also take into consideration travel budget constraints and may interface with a travel reservation service to provide airfare and hotel prices. The association server may interface with the travel reservation service to directly book airfare and hotels for the user, where appropriate. Each user may select the constraints they wish to use and the values for those constraints. For example, a recruit may designate travel expenses as a constraint and may specify the travel budget they would like to use. For example, a recruiter may wish to designate a number of events as a constraint, and may specify the maximum number of events the recruiter is willing to attend. This recruiter might not have a travel budget constraint and this recruit might not have a maximum number of events constraint, each user is given the capability to establish their own constraints for the purposes of itinerary optimization. Moreover, each constrain may be designated a hard constraint, which cannot be violated, and a soft constraint, which the association server takes into consideration but is able to relax the constraint, in performing itinerary optimization, where a sufficiently small change in the constraint may provide a sufficiently large increase in fitness score. Each user may be able to change constraint values as the itinerary optimization is updated so the user can see how itinerary optimization changes as constraints are varied.

As discussed above, exemplary embodiments of the present invention may provide multiple match suggestions, multiple suggested athletes presented to each recruiter, and multiple suggested recruiters presented to each recruit. In both cases, the match may be scored according to a strength thereof. The match score may be presented to the users, for example, on a scale of 0 to 100%, where 0% represents no match and 100% represents a total match.

From there, each user may make use of the scored matches to manually make changes to their itinerary/calendar, to have the automatic itinerary optimization performed, or to generate a list of strongest recommendations for events to attend.

Exemplary embodiments of the present invention have been described herein in terms of high school athletes' recruitment into collegiate sports, however, exemplary embodiments of the present invention are not necessarily limited to such embodiments. For example, exemplary embodiments of the present invention may relate to professional athlete recruitment, or more generally, to any recruitment scenario where direct observation and/or video observation of athletes is desired. For example, exemplary embodiments of the present invention may be applied, more generally, to talent scouting in performance arts.

The process of matching, described above, may be performed in any of a number of different ways. However, in general, matching may either be performed by matching recruiters to athletes, athletes to recruiters, and/or events to recruiters/athletes. In performing this matching, athletes may provide data about themselves such as: gender, graduation year, athletic position(s) played, dominant hand, academic grades, height, weight, etc. Recruiters may provide information about their athletic program and/or the types of athletes they are looking for, such as: gender and position(s) of desired athletes, competitive level of athletic program (e.g. national college athletic association division number, sport-specific divisions), status of college as junior college or four-year college, status of college as private or public, size of student body of college, cost of attending college, academic selectivity of college, degrees and courses offered at college, etc.

As discussed above, matching may be performed both by directly matching desires of one user group (athletes and recruiters) with the characteristics of the other user group (a process referred to herein as explicit matching), and/or by clustering the users by group and recommending top choices of one user to other users within the same cluster [mapping] (a process referred to herein as implicit matching). Explicit matching, in accordance with exemplary embodiments of the present invention, may be performed as follows:

$$PercentageScore ( event x ) = \frac{\frac{Score ( event x )}{MaxScore} \times 100}{2} + 50$$

Here, the PercentageScore for an event (event x) represents the level by which a particular event (event x) is recommended to a particular user. This value may be calculated as a value from 50% to 100%, as provided above. The actual score for the particular event “Score(event x)” may be calculated as follows:

Score(event x)=4×AMS(event x)+0.5×inmplicitAMS(event x)+FitWeight(event x)+Coaches(event x)

Here the score is calculated based on a weighting of various factors, with minor factors such as implicitAMS, FitWeight, and Coaches, as well as the major factor, attendance match score (AMS).

The AMS may be calculated as follows:

$$AMS ( event x ) = {\sum }_{allcollegesattending} CollegeTier ( user , college )$$

Here, the AMS is a score stun across all colleges attending a particular event. For each college attending, specific match scores CollegeTier (user, college) are considered. These values are based on the user's stated (e.g. bookmarked tier rating):

$$CollegeTier ( user , college ) = ( \begin{matrix}bookmarked tier 1 \to 2 \\ bookmarked tier 2 \to 1.5 \\ bookmarked tier 3 \to 1 \\ not bookmarked \to 0\end{matrix} ) \times ( \begin{matrix}yes other party confirmed attending \to 2 \\ maybe other party attending \to 1 \\ no other party not attending \to 0\end{matrix} ) \times ( \begin{matrix}Prospect Day event \to 2 \\ Comp \text{/} Clinic \to 1.5 \\ Tournament \text{/} Showcase \text{/} League \text{/} Tryout \text{/} Other \to 1\end{matrix} )$$

As used above, the bookmarked tier refers to a member of the match list. The status indicator “confirmed attending” relates to a user being scheduled as “will attend” with respect to an event. The status indicator “maybe” relates to a used being scheduled as “maybe” attending or “interested.” The status indicator “no other party not attending” indicates that there are no match list users scheduled to attend or “maybe” attend. Moreover, a category of event may carry a weighting, with here the category of “Prospect Day event” being given the highest weight, followed by “Camp/Clinic” and then “Tournament/Showcase/League/Tryout/Other” being given the lowest weight. The event class may be set by the generating user (e.g. the event coordinator user) at the time of event generation.

Here, colleges rated by the user as “tier 1” are given a weighting of 2, colleges rated by the user as “tier 2” are given a weighting of 1.5, colleges rated by the user as “tier 3” are given a weighting of 1, and colleges not bookmarked (given no rating) are not weighted. Of course, this weighting may be changed according to preferences and this weighting represents the answer to the question of whether it is preferable to be seen by more recruiters from lesser desired athletic programs or fewer recruiters from more highly desired athletic programs.

As for the minor factors, implicitAMS may be calculated as follows:

$$implicit AMS ( event x ) = {\sum }_{allcollegesattending} CalcWeight ( college ) \times CollegeTier ( user , college )$$

Here, the implicitAMS may represent a sum of the sore of all colleges attending the event, where CalcWeight(college) defines relative weightings of all factors considered.

Further:

FitWeight(event x)=AcademicFit(event x)+Athletic Fit(event x)+Social Fit(event x)

Here, each recruiter may rate athletes based on criteria such as academic fit (AcademicFit), athletic fit (AthleticFit), and social fit (Social Fit), although additional factors may also be considered as part of the FitWeight. The FitWeight for a particular event (event x) is based on the sum of the FitWeight for all athletes attending the event. Again, these values may be based on a determination as to the relative value of few high fitting candidates verses a larger number of lower fitting candidates, and these values may be set according to:

AcademicFit(event x)=UserAcademicFit(user,event x)−2.5

AthleticFit(event x)=UserAthleticFit(user,event x)−2.5

SocialFit(event x)=UserSocialFit(user,event x)−2.5

The value of Coaches (event x) may be calculated as a first value if the recruiter is a head coach (e.g. a value of 1.5) and a second value if the recruiter is an assistant coach. This second value may also be dependent upon the total number of assistant coaches for the athletic program. For example, the value may be the total number of assistants multiplied by 0.5 and then adding 0.5 to that result:

$$Coaches ( event x ) = ( \begin{matrix}head \to 1.5 \\ ( num assistants * 0.5 + 0.5 )\end{matrix} )$$

Other weightings may be used and the above equations and explanations are offered merely as an example of how it may be performed.

Exemplary embodiments of the present invention may also provide for the automatic printing of pertinent material for recruiters attending an event. This information may be based on the bookmarked athletes, other recommended athletes and/or all athletes that will be participating in the event. The printout may include a schedule of game play times and locations of game play, as well as a list of bookmarked/recommended/all athletes along with a selection biographic information for each recruit. The above-described information may be accessed on printed physical paper, and/or a mobile device and/or PC by a recruiter. Additionally, each recruit may have a QR code printed next to his or her name so that a recruiter may, using a handheld mobile device, scan or otherwise observe a recruit and the mobile device may identify the recruit to the recruiter and pull up pertinent data, directly bookmark them, or schedule attendance to future events that the recruit is scheduled to participate in. The event materials may also include a QR code for recruiters and athletes to scan in order to indicate their attendance

Alternatively, each recruit may carry a card or chip that may include NFC technology or the like.

Moreover, exemplary embodiments of the present invention may provide 3^{rd} party application programming interfaces (APIs) so that data pertaining to athletes and athletic programs, including event participation may be accessed via other websites, applications, etc. APIs may also be provided so that the above-described videos and/or livestreams may be embedded in additional websites and applications. In this way, 3^{rd} parties may make uses of the data described above, and users may access the data on other devices, such as set-top boxes, voice activated digital assistants, e-book readers, and the like. Additionally, recruiters and athletes may indicate their attendance directly on 3^{rd} party websites, applications, etc. using the API.

Alternatively, APIs provided by social media networks, such as Facebook, Twitter, etc., may allow athletes to share their profile information directly on their social media account for recruiters to view and bookmark.

3^{rd} party event registration websites, applications, etc. may provide recruiter and recruit information related to user profiles and event attendance. This information may be obtained by API, data file, etc, and used for the above described purposes.

Moreover, user profile and event attendance information may be provided as a result of ancillary items purchased at or for an event, such as film of the games.

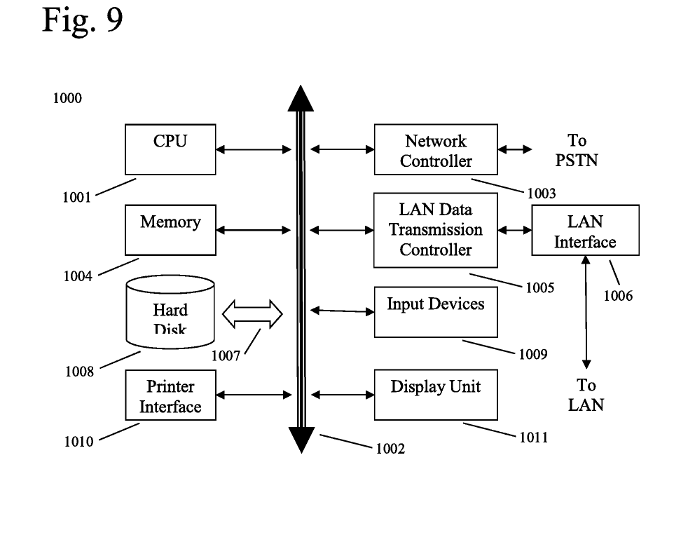

FIG. 9 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure.

What is claimed is:

1. A system for event recommendation and coordination, comprising:
an association server configured to receive athlete information pertaining to a plurality of athlete users, and recruiter information pertaining to a plurality of recruiter users, over at least one web portal; and
a database accessible by the association server and configured to store the athlete information and the recruiter information therein, and to further store event information pertaining to a plurality of events,
wherein the association server comprises:
a browsing module configured to permit the athlete users to browse the recruiter information, to permit the athlete users to browse the event information, to permit the recruiter users to browse the athlete information, and to permit the recruiter users to browse the event information, over the at least one web portal;
a matching module configured to automatically generate event recommendations to each of the recruiter users and the athlete users, the event recommendations recommending events for the respective user to attend; and
a scheduling module configured to maintain calendars for each of the athlete users and recruiter users, each of the calendars configured to include one or more of the plurality of events to which the corresponding user is either scheduled to attend or is scheduled to “maybe” attend.

2. The system of claim 1, further comprising:
a plurality of athlete devices used by the plurality of athlete users for exchanging information with the association server over the one or more web portals; and
a plurality of recruiter devices used by the plurality of recruiter users for exchanging information with the association server over the one or more web portals.

3. The system of claim 2, additionally comprising a calendar service, accessible by the association server, the plurality of athlete devices, and the plurality of recruiter devices, for maintaining the calendars for each of the athlete users and recruiter users.

4. The system of claim 2, wherein the association server further comprises a notification module configured to notify athlete users and recruiter users of changes to scheduled event attendance for events that the corresponding user is scheduled to attend, is scheduled to “maybe” attend, or is not scheduled to attend.

5. The system of claim 4, additionally comprising an email service, accessible by the association server, the plurality of athlete devices, and the plurality of recruiter devices, for generating email notifications in response to commands sent from the notification module.

6. The system of claim 4, additionally comprising a text messaging service, accessible by the association server, the plurality of athlete devices, and the plurality of recruiter devices, for generating text notifications in response to commands sent from the notification module.

7. The system of claim 2, additionally comprising a plurality of event coordinator devices configured to send the event information pertaining to the plurality of events to the association server over the one or more web portals.

8. The system of claim 2, additionally comprising a plurality of coach devices configured to access the scheduling module of the association server to schedule attendance of a subset of athlete users, of the plurality of athlete users, to one or more of the plurality of events.

9. A method for event recommendation and coordination, comprising:
receiving event information pertaining to a plurality of events;
receiving athlete information pertaining to a plurality of athletes;
receiving athlete attendance information pertaining to events of the plurality of events that the plurality of athletes are scheduled to attend;
receiving athletic program information pertaining to a plurality of athletic programs;
receiving recruiter information pertaining to a plurality of recruiters associated with the plurality of athletic programs;
receiving recruiter attendance information pertaining to events of the plurality of events that the plurality of recruiter are scheduled to attend;
generating athlete event recommendations recommending attendance of each of the plurality of athletes to one or more events of the plurality of events, based on the athlete information, the athlete attendance information, the athletic program information, the recruiter information, and the recruiter attendance information; and
generating recruiter event recommendations recommending attendance of each of the plurality of recruiters to one or more events of the plurality of events, based on the athlete information, the athlete attendance information, the athletic program information, the recruiter information, and the recruiter attendance information.

10. The method of claim 9, wherein generating the athlete event recommendations is further based on stated athlete preferences, stated athlete academic attributes, stated athlete athletic attributes, and stated athletic program requirements.

11. The method of claim 9, wherein generating the recruiter event recommendations is further based on stated athlete preferences, stated athlete academic attributes, stated athlete athletic attributes, and stated athletic program requirements.

12. The method of claim 9, wherein the athlete event recommendations and the recruiter event recommendations are generated using a matching algorithm.

13. The method of claim 12, wherein the matching algorithm utilizes computer learning.

14. The method of claim 12, wherein the matching algorithm clusters the plurality of athletes into multiple clusters and athlete/recruiter event recommendations are based on the multiple clusters.

15. A computer system comprising:
a processor; and
a non-transitory, tangible, program storage medium, readable by the computer system, embodying a program of instructions executable by the processor to perform method steps for event recommendation and coordination, the method comprising:
receiving event information pertaining to a plurality of events;
receiving athlete information pertaining to a plurality of athletes;
receiving athlete attendance information pertaining to events of the plurality of events that the plurality of athletes are scheduled to attend;
receiving athletic program information pertaining to a plurality of athletic programs;
receiving recruiter information pertaining to a plurality of recruiters associated with the plurality of athletic programs;
receiving recruiter attendance information pertaining to events of the plurality of events that the plurality of recruiter are scheduled to attend;
generating athlete event recommendations recommending attendance of each of the plurality of athletes to one or more events of the plurality of events, based on the athlete information, the athlete attendance information, the athletic program information, the recruiter information, and the recruiter attendance information; and
generating recruiter event recommendations recommending attendance of each of the plurality of recruiters to one or more events of the plurality of events, based on the athlete information, the athlete attendance information, the athletic program information, the recruiter information, and the recruiter attendance information.

16. The computer system of claim 15, wherein generating the athlete event recommendations is further based on stated athlete preferences, stated athlete academic attributes, stated athlete athletic attributes, and stated athletic program requirements.

17. The computer system of claim 15, wherein generating the recruiter event recommendations is further based on stated athlete preferences, stated athlete academic attributes, stated athlete athletic attributes, and stated athletic program requirements.

18. The computer system of claim 15, wherein the athlete event recommendations and the recruiter event recommendations are generated using a matching algorithm.

19. The computer system of claim 15, wherein the matching algorithm utilizes computer learning.

20. The computer system of claim 15, wherein the matching algorithm clusters the plurality of athletes into multiple clusters and athlete/recruiter event recommendations are based on the multiple clusters.
